(19) United States
(12) Patent Application Publication
(10) Pub. No.: US 2009/0104433 A1
(43) Pub. Date: Apr. 23, 2009

(54) Materials having variable electrical properties based upon environmental stimuli

(76) Inventor: Jifan Li, Irvine, CA (US)

Correspondence Address: BUCHANAN, INGERSOLL & ROONEY PC, POST OFFICE BOX 1404, ALEXANDRIA, VA, 22313-1404, US

(21) Appl. No.: 12/227,411

(22) PCT Filed: May 18, 2007
(86) PCT No.: PCT/US2007/011944

§ 371 Date: Nov. 17, 2008

Related U.S. Application Data
(60) Provisional application No. 60/801,508, filed on May 18, 2006.

(51) Int. Cl. B32B 5/16

(52) U.S. Cl. 428/323

(57) ABSTRACT

A composite material switchable between a first state and a second state having different electrical properties, the composite includes a first material responsive to an environmental stimulus, a plurality of nano-deposits formed from a second material disposed on at least a portion of at least one surface of the first material, the second material includes an electrically conductive material, wherein in response to the environmental stimulus, the plurality of nano-deposits are switchable between a first configuration corresponding to the first state, and a second configuration corresponding to the second state. Related devices and methods are also described.

The present application claims priority, pursuant to Article 4 of the Paris Convention, to U.S. Patent Application Ser. No. 60/801,508 filed May 18, 2006, and the entire contents of which is incorporated by reference herein.

### FIELD OF THE INVENTION

The present invention relates to smart materials which have changeable or switchable properties. For example, materials formed according to the principles of the present invention may have the ability to switch between electrical conductor and insulator states in response to an environmental stimulus.

### BACKGROUND

In the discussion of the state of the art that follows, reference is made to certain structures and/or methods. However, the following references should not be construed as an admission that these structures and/or methods constitute prior art. Applicant expressly reserves the right to demonstrate that such structures and/or methods do not qualify as prior art.

One way to enhance the function and performance of a polymer is to embed nanoparticles within a polymer. Recently, incorporating metal nanoparticles within polymers to achieve tailored electronic properties has drawn great interest. (See, for example, Chegel V. I., Raitman O. A., Lioubashevski O., et al., “Redox-switching of electrorefractive, electrochromic, and conductivity functions of Cu2+/polyacrylic acid films associated with electrodes,” Advanced Materials, 14, 1549 (2002)). Of particular interest is the combination of gold nanoparticles with a smart polymer, which exhibit large changes in their properties in response to small physical or chemical stimuli. An example of such a smart polymer is poly(N-isopropylacrylamide (see Sheeney-Haj-lchia L., Sharabi G., and Willner I., “Control of the electronic properties of thermosensitive poly (N-isopropylacrylamide) and Au-nanoparticle/poly(N-isopropylacrylamide) composite hydrogels upon the phase transition.” Advance Functional Materials, 12, 27-32, 2002; and Zhao X., Ding X., Deng Z., et al., “Thermoswitchable electronic properties of a gold nanoparticles/hydrogel composite,” Macromolecular Rapid Communications, 26, 1784-1787, 2005).

Au nanoparticles/poly(N-isopropylacrylamide) composites have demonstrated switchable electronic properties, such as electrical resistance, in response to temperature changes.

However the range of electrical resistance is limited. For example, even the lowest electrical resistance is around 10KΩ), which is relatively high for an electrical conductor, but the highest electrical resistance is around 70KΩ, which is relatively low for an electrical insulator.

Another disadvantage associated with state-of-the-art switchable materials such as those mentioned above is the formation of uniformly shaped nanoscale particulates, and the challenges associated with their incorporation into a polymeric matrix. Techniques for producing nanoparticles such as those described above are technically challenging with respect to the ability of such processes to control the size, shape and uniformity of the nanoparticles. In addition, handling of such small-scale particular materials presents additional challenges, for example, with respect to their tendency to agglomerate and resist dispersion.

Yet another disadvantage associated with state-of-the-art switchable materials is that their properties tend to be isotropic, i.e., the same in every direction. In certain situations, it would be preferable to provide a material with desired properties only in a certain direction, or properties which are different in different directions, i.e., anisotropic properties.

### SUMMARY

The present invention addresses one or more of the above-mentioned problems associated with the state-of-the-art.

According to one aspect, the present invention provides a composite material switchable between a first state and a second state having different electrical properties, the composite comprising: a first material responsive to an environmental stimulus; a plurality of nano-deposits formed from a second material disposed on at least a portion of at least one surface of the first material, the second material comprising an electrically conductive material; wherein in response to the environmental stimulus, the plurality of nano-deposits are switchable between a first configuration corresponding to the first state, and a second configuration corresponding to the second state.

According to a further aspect, the present invention provides devices such as a sensor, drug delivery device, or microfluidic switch incorporating a material such as that described above.

According to yet another aspect, the present invention provides a composite material switchable between a first the state and a second state having different electrical properties, the composite comprising: a first material responsive to an environmental stimulus comprising a plurality of nanoparticles; a second material disposed on the nanoparticles, the second material comprising an electrically conductive material; wherein in response to the environmental stimulus, the composite material is switchable between a first configuration corresponding to the first state, and a second configuration corresponding to the second state.

According to an additional aspect, the present invention provides a method of forming a composite material of the type described above, the method comprising sputter coating the second material onto the at least one surface of the first material.

According to still another aspect, the present invention provides a composite material, and related methods, that possess switchable anisotropic properties.

As used herein, “nano-deposit(s)” means one or more nanometer-dimensioned features formed by any suitable technique. These features may be formed from one or more nanometer-dimensioned particles and/or agglomerates.

### BRIEF DESCRIPTION OF THE DRAWINGS

FIG. 1 is a schematic illustration of a composite material of the present invention in a first state.

FIG. 2 is a schematic illustration of the composite material of FIG. 1, while in a second state.

FIG. 3 is a schematic illustration of an alternative embodiment of a composite material of the present invention.

FIG. 4 is a schematic illustration of another embodiment of a composite material of the present invention.

FIG. 5 is a schematic illustration of yet another embodiment of a composite material of the present invention.

FIG. 6 is a schematic illustration of a further embodiment of a composite material constructed according to the present invention.

FIG. 7 is a schematic illustration of another embodiment of a composite material constructed according to the present invention.

FIG. 8 is a schematic illustration of a further alternative embodiment of a composite material constructed according to the present invention.

FIG. 9 is a schematic illustration of yet another alternative embodiment of a composite material constructed according to the present invention.

FIG. 10 is a schematic illustration of an additional embodiment of a composite material of the present invention in a first state.

FIG. 11 is a schematic illustration of an additional embodiment of a composite material the present invention in a second state.

FIG. 12 is a schematic illustration of the method of forming a composite material according to the principles of the present invention.

FIG. 13 shows the electrical resistance, during a heating/cooling cycle, of a composite material in accordance with an embodiment of the invention.

FIGS. 14A-14C shows scanning electron micrographs, at various points during a heating/cooling cycle, of a second material deposited on a first material, in accordance with an embodiment of the invention.

FIG. 15 shows the results of an assessment, during a heating/cooling cycle, of the electrical resistance of a composite material formed in accordance with an embodiment of the present invention.

### DETAILED DESCRIPTION

According to the present invention, articles and methods have been developed in connection with composite materials which have a broader range and more tunable properties. In addition, the articles and methods of the present invention enable the production of such composite materials in a manner which provides the above noted improved performance, and facilitate the production of such materials compared with state-of-the-art formation techniques.

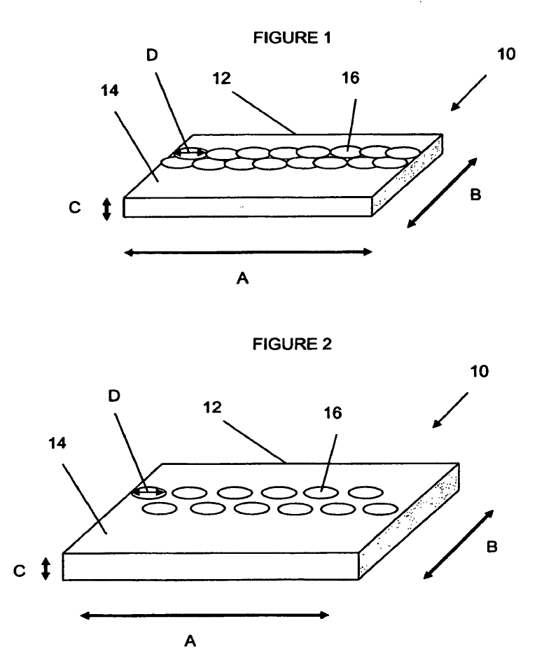

A first exemplary embodiment of the present invention is illustrated in FIGS. 1-2. As illustrated therein, a composite material 10 comprises a first material 12 having a first surface 14. A plurality of nano-deposits 16 are provided on at least a portion of the first surface 14.

The composite material 10 is illustrated as being in a first state in FIG. 1. The composite material 10 may have a first electrical property when in the first state. Thus, for example, when the composite material 10 is in the first state, it is electrically conductive in the direction of the arrow A, but not in the direction of arrows B and C. It is of course possible that in alternative embodiments of the present invention, the composite material 10 may have different properties, electrical or otherwise, while in the first state. In FIG. 2, the composite material 10 is illustrated as being in a second state. The composite material 10 may have a second electrical property when in the second state. Thus, for example, when the composite material 10 is in the second state, it is substantially electrically non-conductive in the direction of arrows A, B or C. It is of course possible that an alternative embodiments of the present invention, the composite material 10 may have properties which differ from that of the illustrative embodiment, electrical or otherwise, while in the second state. Such alternative properties are mentioned above.

The composite material 10 transitions between the first and second states in response to an environmental stimulus. Thus, the composite material 10 is switchable between the first and second states via application of an appropriate stimulus. Any suitable stimuli may be utilized. For example, the composite material is caused to transition between first and second states by stimuli such as temperature, pH, ultraviolet radiation, electrical fields, magnetic fields, infrared radiation, ultrasound, solvents, ions, and biomolecules. According to the illustrative embodiment of FIGS. 1-2, the first material 12 swells in response to changes in temperature such that it transitions between the first shrunken state illustrated in FIG. 1, and a second swollen state illustrated in FIG. 2. The swelling of the first material causes the nano-deposits 16 formed from a conductive second material and disposed on at least a portion of the first the surface 14 to physically separate from one another thereby breaking electrical contact and rendering the composite material 10 substantially nonconductive.

The first material 12 can comprise any suitable material responsive to appropriate stimuli. Thus, for example, the first material 12 can comprise a smart polymer. According to one exemplary embodiment, the first material 12 comprises a hydrogel. According to an additional alternative embodiment, the hydrogel comprises poly(N-isopropylacrylamide). Alternative first materials include: pH sensitive polymers, such as poly(acrylic acid); electrically sensitive polymers, such as polythiophen gel; UV radiation sensitive polymers such as polyacrylamide crosslinked with 4-(methacryloylamino)azobenezene; IR radiation sensitive polymers, such as poly(N-vinyl carbazole) composite; ultrasound sensitive polymers, such as dodecyl isocyanate-modified PEG-grafted poly(HEMA); magnetic field sensitive polymers, such as PNIPAm hydrogels containing derromagnetic material.

The second material can comprise any suitable material which provides a desired property in either the first or second states. For example, the second material can comprise an electrically conductive or semiconductive material. According to one illustrative embodiment, the second material comprises gold. Alternative second materials include: silver, copper, aluminum and silicon.

The plurality of nano-deposits 16 may be partially embedded within the first material 12. However, according to the principles of the present invention it is preferable that the plurality of nano-deposits 16 are not completely embedded within the first material 12, in contrast with the state-of-the-art. The disposition of the plurality of nano-deposits 16 on at least a portion of the first surface 14 provides advantages and benefits not believed to be attainable with composites comprising nanoparticles which are completely embedded within a matrix of the first material. Although not wishing to be bound to any particular theory, in the exemplary embodiment wherein the nano-deposits 16 comprise an electrically conductive material, impediments to movement of the nano-deposits 16 when transitioning between first and second states are significantly reduced due the lack of first material between the nano-deposits 16 or nanoparticles. By contrast, in the state-of-the-art the nanoparticles are embedded within the body or matrix defined by the first material. Thus, according to the state-of-the-art the physical contact between particles necessary to create conductivity within the composite material is impeded by the presence of matrix material interstitially between the embedded nanoparticles. The present invention overcomes this impediment.

The nano-deposits 16 can be formed with any suitable geometry or dimensions. According to certain non-limiting embodiments, the nano-deposits 16 have a major dimension D which is on the order of the dimensions that can be formed in masks using state-of-the art mask forming techniques. According to further non-limiting examples, the dimension(s) D can be on the order of 45 nm or less, and can be as large as a few microns. According to further embodiments, the nano-deposits 16 may be substantially uniform with respect to their dimensions and/or geometries. In addition, the nano-deposits 16 may be substantially uniformly spaced from one another on the first surface 14 in either the second or first state. According to the principles of the present invention, the ability to provide substantially uniform nano-deposits 16 in a substantially uniform pattern on at least a portion of a first surface provides additional advantages to the present invention. In particular, it is believed that by doing so the desired properties can be more accurately controlled via the switching mechanism between the first and second states. Thus, for example, according to the illustrative embodiment switching between first and second states causes the composite material to become conductive and nonconductive, depending upon whether the nano-deposits make sufficient physical contact with one another. A uniform array of uniformly configured nano-deposits improves the predictability of whether these nano-deposits will come into contact with one another upon transition between first and second states, e.g., via swelling/shrinkage.

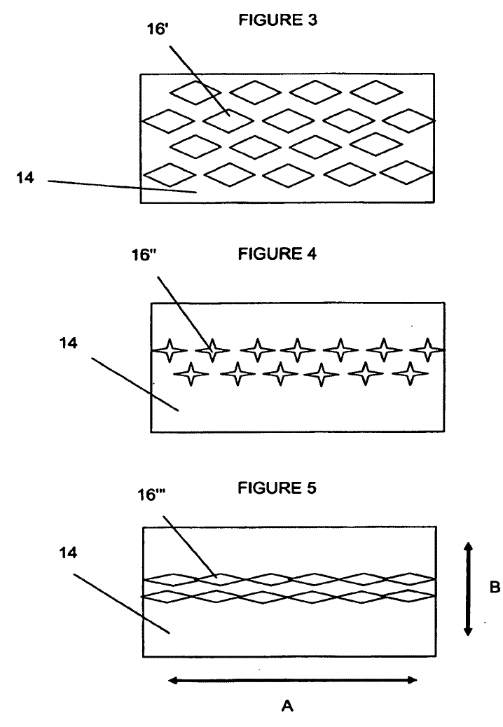

FIGS. 3-5 illustrate alternative embodiments wherein the nano-deposits have alternative geometries. As illustrated in FIG. 3, the nano-deposits 16′ are substantially diamond shaped. According to a further alternative embodiment, and regardless of their shape or geometry, the nano-deposits can be disposed on substantially the entire first surface 14 of a first material, as also illustrated in FIG. 3.

FIG. 4 illustrates an alternative embodiment in which the nano-deposits 16″ are substantially star-shaped. According to a further alternative embodiment, the nano-deposits can be shaped and placed on at least a portion of the first surface 14 in a manner such that the transition between first and second states provides the desired property in a unidirectional manner. Thus, for example, as illustrated in FIG. 5, the nano-deposits 16′″ can be configured such that in a first state they are in physical contact with one another along the direction indicated by arrow A, but not in the direction of arrow B. Thus, when the nano-deposits 16′″ are formed from a conductive material, and electrical conductivity is provided only in the direction indicated by arrow A. The ability to precisely control the geometry and/or dimensions and thereby provide such unidirectional properties along at least a portion of a first surface of a composite material 10 provides yet an additional advantage relative to state-of-the-art composite switchable materials.

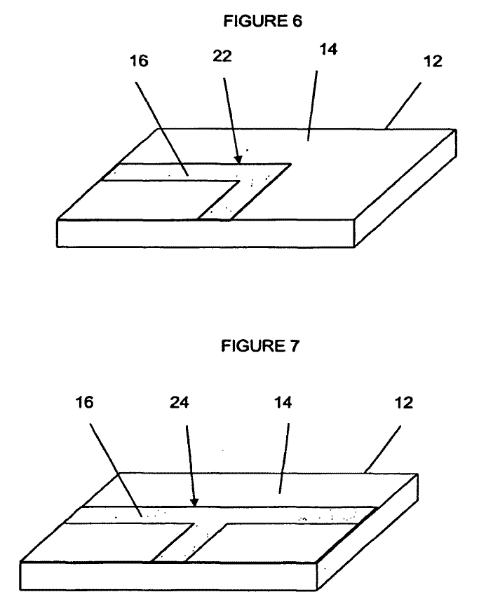

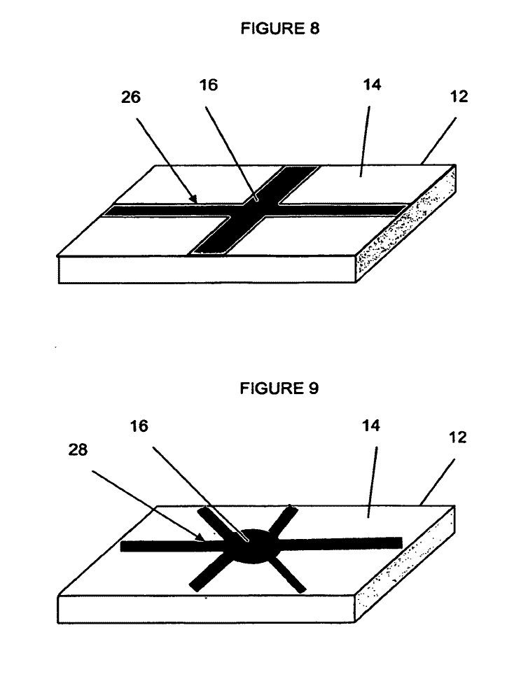

According to further alternative embodiments, and regardless of the shape or geometry, the nano-deposits 16 can be disposed on specific regions of the first surface 14 of a first material 12, as illustrated in FIGS. 6-9. As illustrated in FIG. 6, the nano-deposits 16 can be disposed in a substantially L-shaped region 22 on the first surface 14 of the first material 12. Alternatively, the nano-deposits can be disposed on a substantially T-shaped area 24 on the first surface 14 of the first material 12. The nano-deposits 16 can also be disposed on a substantially cross-shaped area 26 of the first surface 14 of the first material 12, as illustrated in FIG. 8. According to a further alternative, the nano-deposits 16 can be disposed in a region generally comprised of a central hub having one or more spokes emanating therefrom 28, on the first surface 14 of the first material 12, as illustrated in FIG. 9.

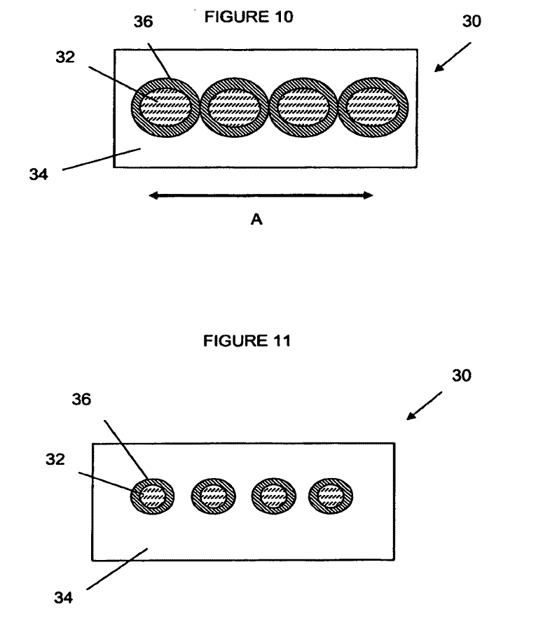

An alternative embodiment of a composite material 30 formed according to the principles of the present invention is illustrated in FIGS. 10-11. As illustrated therein, a plurality of smart particles 32 are arranged on a substrate 34. The smart particles 32 can comprise any suitable material, such as any of the first materials described above. The smart particles 32 may be coated, partially or completely, by a second material 36. A second material 36 can comprise any suitable material, such as any of the second materials described above. The composite material 30 is illustrated as being in a first state in FIG. 10, and a second state in FIG. 11. The properties of a composite material 30 differ between the first and second states. Any suitable properties may be imparted to the composite materials, such as electrical conductivity. The composite material 30 transitions between the first and second states by the application of an appropriate environmental stimulus, such as any of the above described stimuli. Thus, for example, when the particles 32 comprise a hydrogel and the second material 36 comprises an electrical conductor, such as gold, the composite material 30 is conductive at least in the direction of arrow A in the first state illustrated in FIG. 10. Upon application of an appropriate stimulus, such as a change in temperature, the composite 30 transitions to the second state and is rendered nonconductive, as illustrated in FIG. 11.

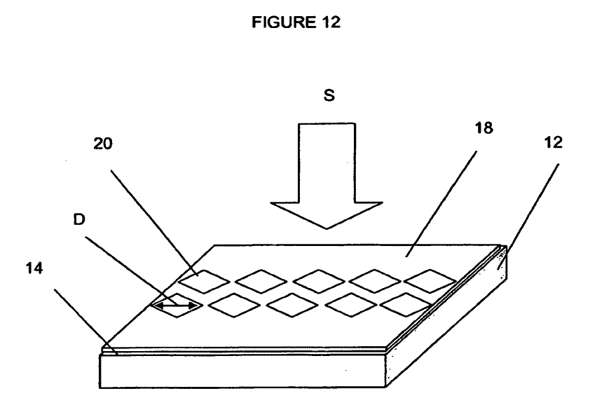

A composite material of the present invention can be formed by any suitable technique. One such suitable technique is illustrated schematically in FIG. 12. As illustrated therein, a mask 18 having any suitably shaped and dimensioned openings 20 is provided on top of at least a first surface 14 of the first material 12. The openings 20 of the mask 18 may optionally have a major dimension D which is on the order of the dimensions that can be formed in masks using state-of-the art mask forming techniques. According to further non-limiting examples, the dimension(s) D of the openings 20 can be on the order of 45 nm or less, and can be as large as a few microns. The second material can be introduced onto at least the first surface 14 through the openings 20 of the mask 18 by any suitable technique, such as a conventional sputter-coating technique schematically illustrated by the arrow S. This technique of forming a composite material according to the present invention provides advantages and benefits over conventional nanoparticle synthesis. The above described is masked sputter coating technique for applying nano-deposits on to a substrate is believed to be quicker, more efficient, and tends to produce nano-deposits which are more uniform in shape and dimension when compared with state-of-the-art nanoparticle synthesis techniques described herein.

The organization of the metal nano-deposits can lead to the exhibition of novel photonic, electronic, sensory, or photoelectrochemical properties. Metal nano-deposits can be used as functional units to conjugate with small or large molecules, such as drugs, biomolecules, and the like. This invention may have broad applications, such as for switches on microfluidic devices, biosensor and gene/drug delivery systems. For example, the material could be used for a switch in a drug delivery device; by changing the temperature of the body part where the drug was to be delivered, the device would only operate to dispense the drug in the desired area. Alternatively, materials that respond to pH could be employed in chemotherapeutic drug delivery devices, as the interstitial pH of tumors is known to be highly acidic. This invention also has great potential application in protective devices. For example, the smart materials could be used in protective devices against electric shock in situations in which the risk of electric shock is linked to changes in the local environment that impart insulating properties to the materials.

### EXAMPLE

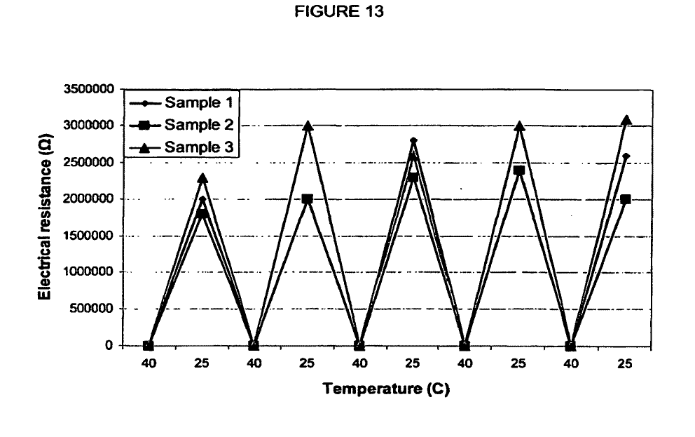

Poly(N-isopropylacrylamide)-chitosan was synthesized as a thermal-sensitive material and the gold nano-deposits were coated on a surface thereof through a plain paper mask using a conventional sputter coating technique. The electrical resistance of the composite structure was measured using a Fluke 179 True RMS Multimeter at 25° C. and 40° C. under many cycles. The results are shown in FIG. 13.

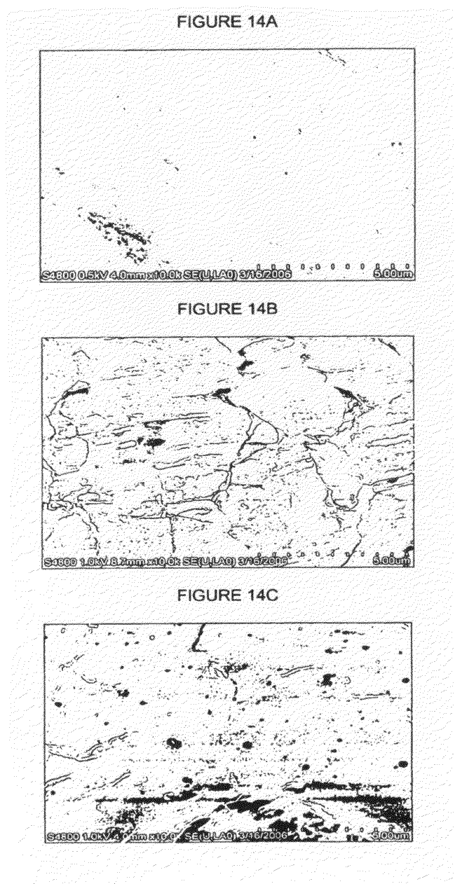

From FIG. 13, it can be seen that the change in the electrical resistance of the composite through a heating/cooling cycle is extremely large. At a high temperature (40° C.), the electrical resistance of the gold membrane on the surface of the hydrogel is very low (varying from 30Ω to 400Ω) so that the material is electrically conductive. However at 25° C., the electrical resistance becomes significantly large (more than 2.0 MΩ). The reason for this is that the distance between the gold particles increases or diminishes with the swelling or shrinking of this thermal-sensitive polymer at different temperatures. These phenomena can be observed under SEM, as shown in FIGS. 14A-14C. The process of the switch between the conductor and insulator upon the temperature change can undergo many cycles so that the change is continuous. The experimental results are consistent and reproducible. Thus the electronic property of this hydrogel presents excellent thermoswitchability.

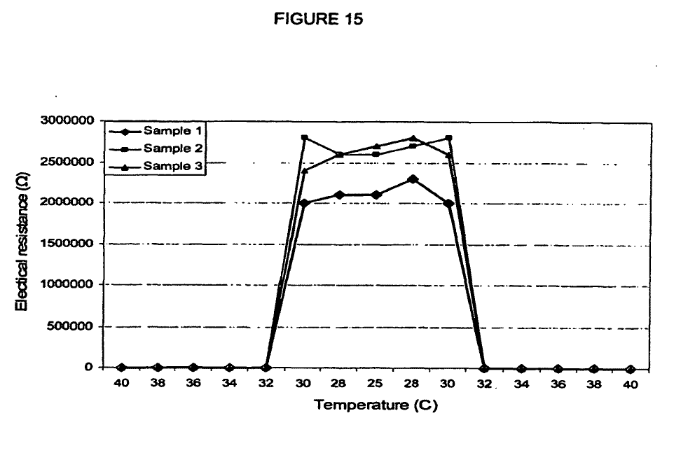

However, a wide range existed between 25° C. and 40° C. Thus to precisely investigate the change of the electrical resistance upon the temperature in this range, the electrical resistance of the composite was measured every 2° C. between 25° C. and 40° C. The results are shown in FIG. 15.

FIG. 15 shows that the change of the electrical resistance of the composite was not gradual with change of the temperature. A sudden and dramatic change was observed at 32° C. during the heating/cooling cycle. When the temperature is below 32° C., the electrical resistance of the composite is extremely large (more then 2MΩ) but above 32° C. the electrical resistance becomes very low. It seems that at 32° C. the extent of the swelling of the hydrogel is large enough to disrupt the gold film and divide it into several isolated parts so they are no longer electrically conductive. In this embodiment, 32° C. was the critical temperature for the change in the electrical properties. The critical temperature of 32° C. is the same as the low critical solution temperature (LCST) of polyNIPAm-chitosan hydrogels. It indicates that the dramatic change of electrical properties happens at the LCST of the hydrogel due to the significant volume change associated with the LCST. Since the LCST of polyNIPAm can be adjusted by adding hydrophilic or hydrophobic components, according to the present invention, the threshold temperature for switching the electrical properties of the hydrogel composite can be adjusted to match specific application requirements.

All numbers expressing quantities of ingredients, constituents, reaction conditions, and so forth used in the specification are to be understood as being modified in all instances by the term “about”. Notwithstanding that the numerical ranges and parameters setting forth, the broad scope of the subject matter presented herein are approximations, the numerical values set forth are indicated as precisely as possible. Any numerical value, however, may inherently contain certain errors as evident from the standard deviation found in their respective measurement techniques, or by rounding off.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A composite material switchable between a first the state and a second state having different electrical properties, the composite comprising:
a first material responsive to an environmental stimulus;
a plurality of nano-deposits formed from a second material disposed on at least a portion of at least one surface of the first material, the second material comprising an electrically conductive material;
wherein in response to the environmental stimulus, the plurality of nano-deposits are switchable between a first configuration corresponding to the first state, and a second configuration corresponding to the second state.

2. The material of claim 1, wherein the electrical property comprises electrical resistance.

3. The material of claim 1, wherein the first material comprises at least one of:
poly(N-isopropylacrylamide); poly(acrylic acid); polythiophen gel; polyacrylamide crosslinked with 4-(methacryloylamino)azobenezene; poly(N-vinyl carbazole) composite; dodecyl isocyanate-modified PEG-grafted poly(HEMA); and PNIPAm hydrogels containing derromagnetic material.

4. The material of claim 1, wherein the second material comprises a conductive or a semiconductive material.

5. The material of claim 4, wherein the second material comprises at least one of: gold, silver, copper, aluminum and silicon.

6. The material of claim 1, wherein the plurality of nano-deposits are limited to the first the surface.

7. The material of claim 1, wherein the plurality of nano-deposits comprise a plurality of separate and discrete features.

8. The material of claim 1, wherein each of the nano-deposits comprise a feature, each of the plurality of features having substantially uniform dimensions and geometry relative to one another.

9. (canceled)

10. The material of claim 8, wherein the geometry is: round, oval, polygonal, diamond-like, or star-like.

11. The material of claim 1, wherein the composite material is electrically conductive in one of the first or second states, and is nonconductive in the other state.

12. The material of claim 1, wherein the nano-deposits are configured so as to provide unidirectional electrical conductivity in one of the first or second states.

13. The material of claim 1, wherein the first material comprises Poly(N-isopropylacrylamide)-chitosan.

14. The material of claim 1, wherein the plurality of nano-deposits comprises a sputter-coated layer of metallic material on the first surface.

15. The material of claim 1, wherein each of the nano-deposits comprises a major dimension which is no greater than about 45 nm.

16. The material of claim 1, wherein the environmental stimulus comprises at least one of: temperature, pH, ultraviolet radiation, electrical fields, magnetic fields, infrared radiation, ultrasound, solvents, ions, and biomolecules.

17. The material of claim 1, wherein the plurality of nano-deposits are provided over the entirety of the one surface of the first material.

18. The material of claim 1, wherein the plurality of nano-deposits are provided over a limited area to find on the one surface of the first material, the limited area comprising at least one of the following geometries: a straight line, an L-shaped region; a T-shaped region; a cross-shaped region; or a hub and spoke-shaped region.

19. A sensor comprising the composite material of claim 1.

20. A drug delivery device comprising the composite material of claim 1.

21. A microfluidic switch comprising the composite material of claim 1

22. A composite material switchable between a first the state and a second state having different electrical properties, a composite comprising:
a first material responsive to an environmental stimulus comprising a plurality of nanoparticles;
a second material disposed on the nanoparticles, the second material comprising an electrically conductive material;
wherein in response to the environmental stimulus, the composite material is switchable between a first configuration corresponding to the first state, and a second configuration corresponding to the second state.

23. The composite material of claim 22, wherein the nanoparticles comprise a hydrogel material, and the second material comprises a gold coating covering each of the nano-particles.

24. A composite material of claim 22, wherein the coated nanoparticles are in contact with each other in the first state, and are separated from each other in the second state.

25.-26. (canceled)
